(19) United States
(12) Patent Application Publication
(10) Pub. No.: US 2004/0240803 A1
(43) Pub. Date: Dec. 2, 2004

(54) Use of chip-on-board technology to mount optical transmitting and detecting devices with a protective covering with multiple optical interface options

(76) Inventors: David L. Rechberger, Boulder, CO (US); Carl Embry, Boulder, CO (US)

Correspondence Address: BARLOW, JOSEPHS & HOLMES, LTD., 101 DYER STREET, 5TH FLOOR, PROVIDENCE, RI, 02903, US

(21) Appl. No.: 10/872,104

(22) Filed: Jun. 18, 2004

Related U.S. Application Data
(63) Continuation of application No. 09/676,696, filed on Sep. 29, 2000.
(60) Provisional application No. 60/162,828, filed on Nov. 1, 1999.

(51) Int. Cl. G02B 6/36

(52) U.S. Cl. 385/93

(57) ABSTRACT

A packaging system for optoelectronic devices that does not require the optoelectronic device to be hermetically sealed, whereby the optoelectronic device is mounted directly on a substrate, allowing for high-speed trace designs up to the die for excellent high speed signal integrity and EMI performance.

### CROSS-REFERENCE TO RELATED APPLICATION(S)

This application claims priority to U.S. Provisional Patent Application No. 60/162,828 filed Nov. 1, 1999, the contents of which is hereby incorporated by reference.

This application is a continuation of co-pending U.S. patent application Ser. No. 09/676,696, filed Sep. 29, 2000.

### FIELD OF THE INVENTION

This invention generally relates to packaging systems for high speed electro-optical products and more particularly to a system and method for mounting high speed electro-optical devices directly onto a substrate (such as a rigid printed circuit board, flex circuit, flex rigid circuit, ceramic chip or other electrical substrate), with a protective cover, providing multiple optical interface options.

### BACKGROUND

Over the past decade, the demand for increased bandwidth and data transmission rates (gigabit and above communications) has forced the data communications and telecommunications infrastructure to evolve beyond the limits of traditional copper based transmission media to the higher bandwidth which can be achieved with fiber optics. Light transmitted by fiber optic cables is, in most instances, produced by a light emitting semiconductor device which is optically coupled to an end face of a fiber optic cable. In fiber optic systems and certain other applications, an optical subassembly for coupling the laser beam to the fiber includes a hermetic metal package, a metal or plastic ferrule and one or more lenses.

A typical hermetic metal package, conventionally known as a TO Can assembly 10, is shown in FIG. 1. The TO Can assembly 10 forms a hermetic seal for an optoelectronic device 12, and a photodetector 14. The optoelectronic device 12 can be configured as any transmitter, any receiver, or integrated transceiver, i.e. an integrated monolithic package with a transmitter, monitoring photodetector, a photodiode receiver, and an amplifier, or any sub-set thereof, integrated into a single device. Therefore optoelectronic device 12 may include, but need not be limited to, vertical cavity surface emitting lasers (VCSEL) as shown in FIG. 1, edge emitting lasers, LED's, photodiodes, etc. The TO Can assembly 10 further includes a cap 16 having an aperture covered by a window 18 that may be substantially parallel to the output facet of optoelectronic device 12.

The photodetector 14 is positioned to monitor a portion of the radiated light reflected from the window 18. If required, a non-perpendicular interface (not shown) at a predefined angle relative to the output facet of optoelectronic device 12 may be utilized to maximize the reflected light onto the surface of the monitoring device. The output current of the photodetector 14 is proportional to the amount of light incident upon it and is typically fed back as an input to the drive circuitry of optoelectronic device 12. This feedback mechanism is used to adjust the drive current of the optoelectronic device 12 to maintain a consistent output from optoelectronic device 12 over temperature and time.

In a conventional optical package, a standoff 20, the photodetector 14, and the optoelectronic device 12 are mounted onto a TO header 22 with a conductive epoxy (not shown). As is known in the art, wire bonding may be used to ultrasonically weld very fine bond wires 24 from TO header pins 26 to metallized terminal pads (not shown) along the periphery of the integrated circuit chip. Typically the bond wires 24 are made from aluminum or gold, with small alloying additions to achieve the desired handling strength.

A primary disadvantage of conventional packaging approaches for high-speed optical transceivers is the length of the TO header pins 26 and the length of the bond wires 24. Current pulses propagating along the elongated TO header pins 26 emit electromagnetic radiation (EMI), which may cause difficulties passing FCC regulations. These elongated TO header pins may also act as receiving antennae and degrade the signal via crosstalk between the header pins and reception of other incoming EMI signals. Similarly, elongated TO header pins 26 result in distributed inductances that can limit modulation speeds and reduce pulse shape integrity.

In addition, the process of assembling the metal package, including hermetically sealing the electro-optic device, drives the cost of fabricating optical assemblies. Conventional packaging approaches typically place the entire TO Can assembly 10, without the TO cap 16, inside a furnace. The temperature of the furnace is increased to the cure temperature of the epoxy that is used for bonding the standoff 20 to the TO header 22. The TO Can assembly 10 is then placed in a vacuum chamber and purged with dry nitrogen. Typically, TO cap 16 is resistively welded to TO header 22. Finally, fine and gross leak tests are typically performed on TO Can assembly 10 to verify the integrity of the seal.

Existing packaging techniques for high-speed optoelectronic devices also suffer from high material costs for assembly components such as for example the TO cans, butterfly packages, mini-DILs, etc. In addition, restrictive handling requirements for the TO header 22 create difficulties in automating the downstream assembly process so that the costs associated with automating the conventional assembly process are quite high. As a result, conventional packaging techniques incur excessive labor costs for what is typically a manual assembly process (manual lead forming and manual soldering of OSAs onto a substrate). The cost of conventional packaging approaches is further increased by the need for specialized equipment to weld the TO cap 16 to the TO header 22 in a hermetic atmosphere, as well as equipment to verify the integrity of the seal.

Accordingly, it would be advantageous to provide a process for packaging high speed electro-optic devices that does not require hermetic sealing, does not degrade signal integrity through added inductance and cross-talk, and which preferably has minimal electromagnetic radiation.

### SUMMARY OF THE INVENTION

There is therefore provided according to a presently preferred embodiment of the present invention, a method and apparatus for mounting optoelectronic devices onto a high speed capable substrate (as defined above) and affixing an enclosure to the substrate so as to protect the optoelectronic device from the surrounding environment.

In one aspect of the present invention the enclosure is a plastic that substantially encapsulates the optoelectronic device. The plastic enclosure may have optical lensing capabilties to focus the transmitted light into the end face of a fiber or to focus incoming light from the end face of a fiber to a photodetector.

In another aspect of the present invention an optical device package a method and apparatus for mounting optoelectronic devices onto a substrate (as defined above) and affixing an enclosure to the substrate so as to protect the optoelectronic device from the surrounding environment further includes a fiber coupling assembly having a barrel which operably engages a fiber optic cable and an alignment guide structure for passively aligning the fiber coupling assembly to the optical device. In one aspect of the present invention the barrel of the fiber coupling assembly is non-cylindrical in cross-sectional shape.

It is understood that other embodiments of the present invention will become readily apparent to those skilled in the art from the following detailed description, wherein it is shown and described only embodiments of the invention by way of illustration of the best modes contemplated for carrying out the invention. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### DESCRIPTION OF THE DRAWINGS

These and other features of the present invention will be better understood by reading the following detailed description in conjunction with the accompanying drawings, wherein:

FIG. 1 is a cross sectional diagram of an optoelectronic device mounted in a conventional TO Can, such as a TO-46, TO-52, TO-56 or any other conventional metal package;

FIG. 2 is a cross sectional diagram of an optoelectronic device mounted directly on a substrate in accordance with an exemplary embodiment of the present invention;

FIG. 3 is a top view of an optoelectronic device mounted directly on a substrate in accordance with an exemplary embodiment of the present invention;

FIG. 4 is a cross sectional view of a multi-layer substrate to reduce EMI emissions and susceptibility in accordance with an exemplary embodiment of the present invention;

FIG. 5 is a cross sectional view of an optoelectronic device mounted directly on a substrate coupled with a fiber coupling assembly with alignment guide structures in accordance with an exemplary embodiment of the present invention;

FIG. 6 is a cross sectional view of typical registration marks and holes included on a fiber coupling assembly for use in a vision alignment system in accordance with an exemplary embodiment of the present invention;

FIG. 7a is a perspective of a conventional cylindrical barrel of a fiber coupling assembly mated with a fiber cable;

FIG. 7b is a cross sectional view of the barrel shape;

FIGS. 7c-e are cross sectional views of alternate barrel shapes in accordance with an exemplary embodiment of the present invention;

FIG. 8a is a cross sectional view of an optoelectronic device mounted directly on a rigid substrate along with a fiber coupling assembly in accordance with an exemplary embodiment of the present invention;

FIG. 8b is a cross sectional view of an optoelectronic device mounted directly on a flex-rigid substrate along with a fiber coupling assembly in accordance with an exemplary embodiment of the present invention;

FIG. 8c is a perspective view of an optoelectronic device mounted directly on a rigid substrate with castellations for electrical connection to a secondary rigid substrate in accordance with an exemplary embodiment of the present invention;

FIG. 9 is a cross sectional view of an optoelectronic device, encapsulated in plastic, mounted directly on a substrate in accordance with an exemplary embodiment of the present invention; and

FIG. 10 is a cross sectional view of an optoelectronic module, encapsulated in plastic, mounted directly on a substrate, along with a fiber coupling assembly in accordance with an exemplary embodiment of the present invention.

### DETAILED DESCRIPTION OF THE INVENTION

There is therefore provided according to an exemplary embodiment of the present invention, a process for packaging high speed electro-optic devices that does not require hermetic sealing. In accordance with an exemplary packaging system, an optoelectronic device may be mounted directly on a substrate, thereby substantially reducing signal degradation and EMI.

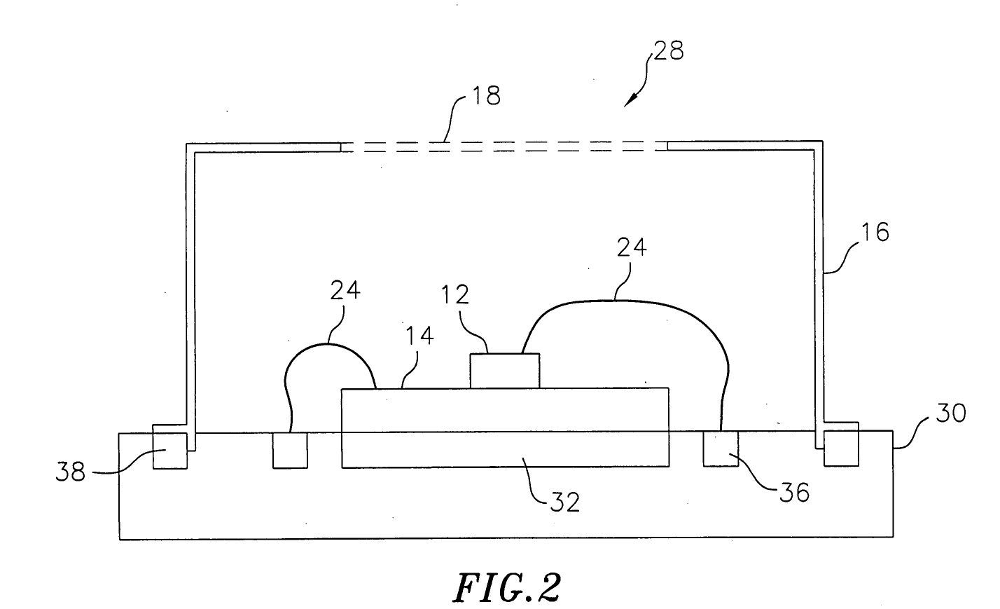

Referring to the cross section of FIG. 2, an exemplary optical package includes an optical module 28 built directly on a substrate 30. The optical module 28 may include an optoelectronic device 12, a power monitoring photodetector 14, and a TO cap 16 having an aperture covered by a window 18. The window 18 may be flat, angled, or an embedded lens configuration. Power monitoring photodetector 14 may be epoxy bonded, as is known in the art, on a conductive mounting pad 32 on substrate 30.

Conductive mounting pad 32 may be formed from any suitable conductive material but is preferably gold. A variety of known techniques for manufacturing substrate circuitry, such as for example, electrolysis, electro-plating, or vapor deposition may be used to deposit conductive mounting pad 32 on substrate 30. In addition attachment pads 36 are deposited on substrate 30 by any one of a variety of known techniques to facilitate wire bonding of optoelectronic device 12 and powering monitoring photodetector 14. Attachment pads 36 can be constructed from any suitable conductive material but are preferably gold.

The optoelectronic device 12 and power monitoring photodetector 14 may be electrically coupled to substrate 30 through a variety of techniques including, for example flip chip or BGA mounting. A preferred embodiment of the present invention minimizes the length of the connections coupling the substrate 30 to the optoelectronic device 12 and the power monitoring photodetector 14. Minimizing the length of the electrical connections is most easily achieved through the utilization of a flip chip mounting technique, as is known in the art. When bond wires 24 are used to couple the substrate and the optoelectronic device, the wires 24 are preferably gold with a diameter in the range of approximately 15-25 μm.

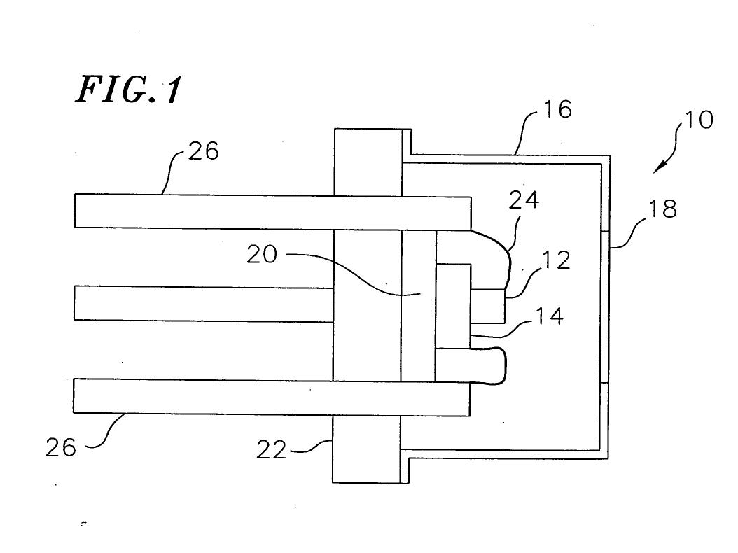

Typically, TO cap 16 is mounted on a sealing pad 38. Sealing pad 38 is preferably gold, but may be one of a variety of conductive materials that are used in the manufacture of substrates. In addition, numerous known techniques may be used to deposit sealing pad 38 on substrate 30. The TO cap 16 can be attached by one of a variety of known methods, including for example, resistive welding, laser welding or epoxy bonding. Advantageously, the TO header pins (see FIG. 1) are eliminated by directly building optical module 28 on substrate 30. This eliminates the complex manufacturing process of lead forming and attachment, resulting in considerable cost savings over conventional packaging techniques.

In addition, the elimination of the TO header pins permits a larger power monitoring photodetector 14 to be integrated into optical module 28 without increasing the footprint of the optical module. Advantageously, a larger photodetector 14 may capture a greater percentage of the reflected light, so as to provide more accurate feedback control of the optoelectronic device 12.

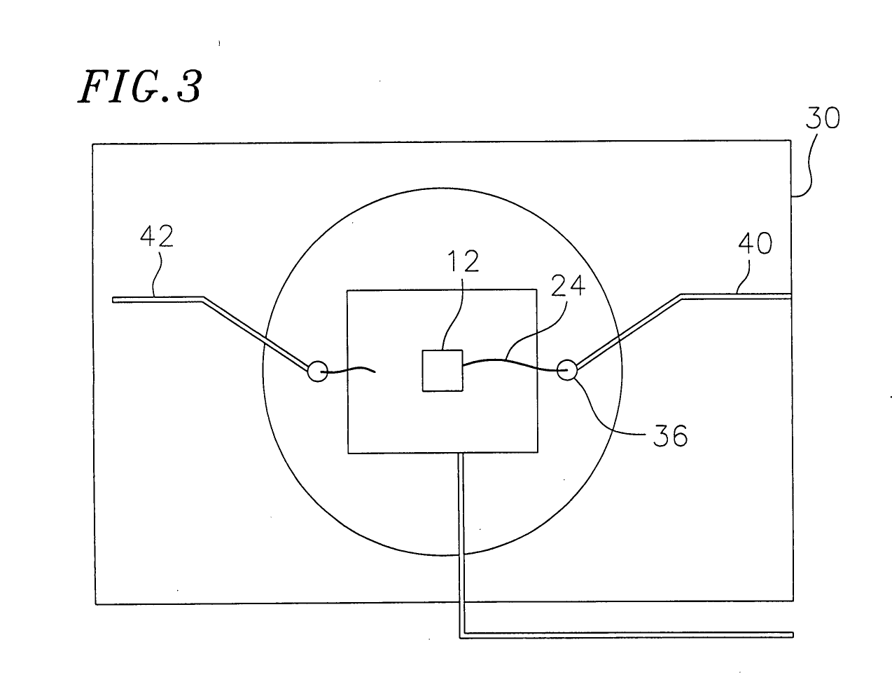

In addition, the direct mounting of optical module 28 on substrate 30 and the subsequent elimination of the TO header pins 26 also provides for improved high speed performance, as well as improved thermal, and EMI performance over conventional packaging techniques. As shown in the top view of FIG. 3, the drive current of optoelectronic device 12 does not propagate through TO header pins but rather through optical device traces 40 and 42 on substrate 30. A preferred embodiment of the present invention substantially reduces the effect of cross-talk between the current that drives the optoelectronic device and the feedback current output by the monitoring photodiode. An exemplary substrate may include for example, high speed impedance matching designs to reduce cross-talk between traces 40 and 42. Such impedance matching designs are possible on a substrate, but can not be utilized in a conventional packaging method that utilizes TO header pins.

An exemplary substrate preferably includes differential input and output designs. Traces 40 and 42 are representations of the input and output signals. The actual implementation of this embodiment may require multiple traces in place of the shown single trace. In addition, one of ordinary skill will appreciate that the substrate may include transmission line or waveguide structures to transmit the electrical signals and maintain high speed signal integrity. Wave guide structures may include, for example, co-planar waveguides, micro-strips or strip lines.

If required, EMI (susceptibility and emissions) shielding may be implemented in accordance with a variety of techniques to improve the signal integrity between optoelectronic devices and to help pass required agency certifications. For example, EMI shielding may be accomplished with a multi-layer structure in which optical device trace 40 and optical device trace 42 are formed in different layers of the substrate separated by an insulating material.

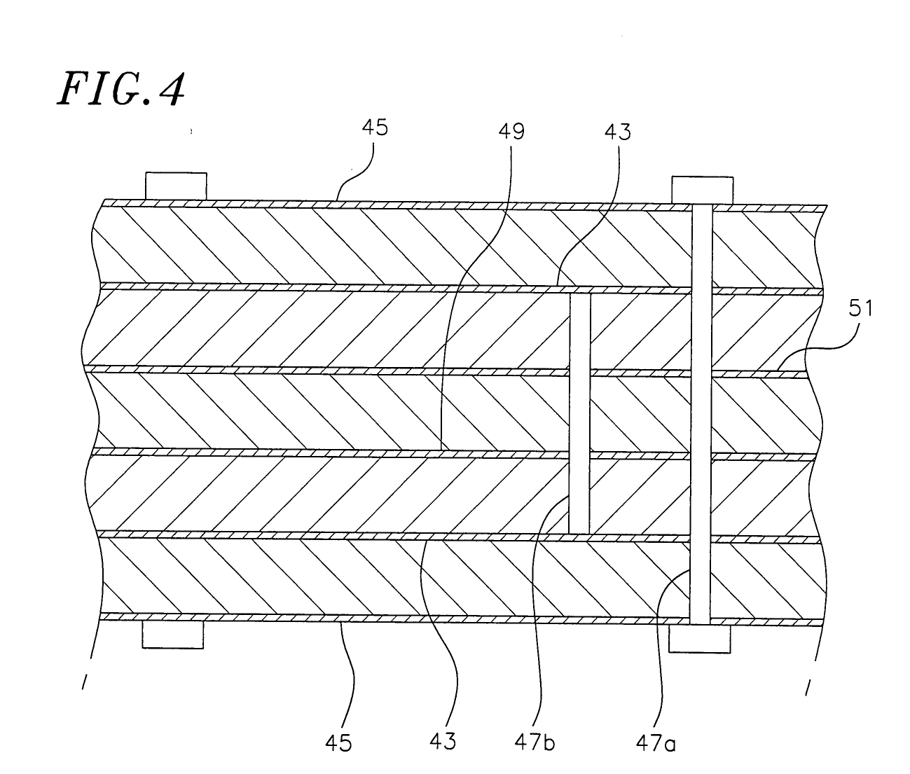

In a preferred embodiment of the present invention, the individual layers of the multi-layer substrate 30 are impedance controlled to assure optimal AC coupling between appropriate layers. FIG. 4 shows an example where the outer layers of the multi-layer flex-rigid substrate AC couple signal ground plane 43 and case ground plane 45. AC coupling the signal ground plane 43 and the case ground plane 45 shields the optoelectronic device 12 from electromagnetic energy emitted by signal conditioning circuitry or other external sources as well as reduces the effects of EMI emissions from application circuit components that may be resident on substrate 30. In an exemplary embodiment of the present invention, the impedance between the signal ground and case ground is preferably optimized for the appropriate frequency range i.e. the frequencies range over which the EMI sources operate.

In addition, the inner layers preferably include vias 47a and 47b that DC couple the respective ground planes 43 and 45 on each side of the signal 49 and Vcc 51 for maximum EMI shielding. The impedance between signal 49 and signal ground 43 is preferably about 50 to 75 Ohms. In accordance with a preferred embodiment, the case ground 45 and signal ground 43 are not DC coupled for ESD protection.

Referring to FIG. 5, a fiber coupling assembly (FCA) 44 may be used to couple the transmitted optical signal from the source to a fiber 50 (TX), or to focus the incoming optical signal from the fiber to a detector (RX). The FCA 44 contains a focusing lens 48 and a barrel 46 that accepts the fiber 50. Reliable high speed optical transmission requires accurate optical alignment (i.e. efficient light coupling) between the optoelectronic device 12 and the focusing lens 48, as well as between the lens 48 and fiber 50. Alignment difficulties may be introduced by characteristics of both the fiber 50 and the optoelectronic device 12.

With regard to the fiber 50, the fiber core (i.e., input face) of a typical cable is quite small. For example, the core diameter of a multi-mode fiber is approximately 63.5 μm to 50 μm in diameter. Single mode fiber are typically 9 μm in diameter. In addition, semiconductor lasers typically have divergence angles in the range of approximately 16-60 degrees presenting a relatively narrow beam that must be accurately focused into the fiber 50. For efficient light coupling the optoelectronic device 12 and multi-mode fiber 50 should be closely centered so that approximately a 5-10 micron total variation between the center of the optoelectronic device 12, lens 48, and the fiber 50 is preferably maintained. For single mode fiber, the centering of the optoelectronic device 12, lens 48, and fiber 50 is preferably held to approximately 1 micron.

Therefore, in one embodiment of the present invention optical module 28 and FCA 44 are actively aligned by performing one or more alignment adjustments on each assembly. During active alignment, a fiber 50 is inserted in the barrel 46 of the FCA 44 and power is applied to optoelectronic device 12. For transmitter alignment, optical power out of the fiber 50 is monitored while optical module 28 is translated with respect to FCA 44 until the launched power is optimized. For receiver alignment the fiber 50 emits light and the optical module 28 may be translated relative to FCA 44 to optimize receiver electrical output.

Next, the subassemblies are fixed with relation to each other. This can be done in a number of ways known in the art, such as laser welding, sonic welding, heat staking, or epoxy. However, the forces normally exerted upon the subassemblies during laser welding or the epoxy cure cycle may cause misalignment between optical module 28 and FCA 44. Therefore, in an alternate embodiment of the present invention, alignment guide structures are integrated into FCA 44 as well as substrate 30. For example, an exemplary embodiment includes vias in substrate 30 and molded guide pins 52 on FCA 44.

The mechanical alignment guide structures minimize subsequent misalignment when FCA 44 is mounted to substrate 30. Advantageously, simply inserting the molded guide pins 52 into the vias on the substrate 30 provides an initial gross alignment of optical module 28 and FCA 44. For multi-mode and receiver applications, this initial alignment may be the only required alignment step. A preferred embodiment of a passive alignment coupling assembly is disclosed in U.S. Pat. No. 6,015,239, entitled “PASSIVELY ALIGNED OPTO-ELECTRONIC COUPLING ASSEMBLY”, the contents of which are hereby incorporated by reference. If additional alignment is required, active alignment may then be used to precisely align the FCA 44 and the optical module 28. The FCA 44 may then be secured via a number of known methods including, for example, epoxy bonding, sonic welding, heat staking, laser welding, etc.

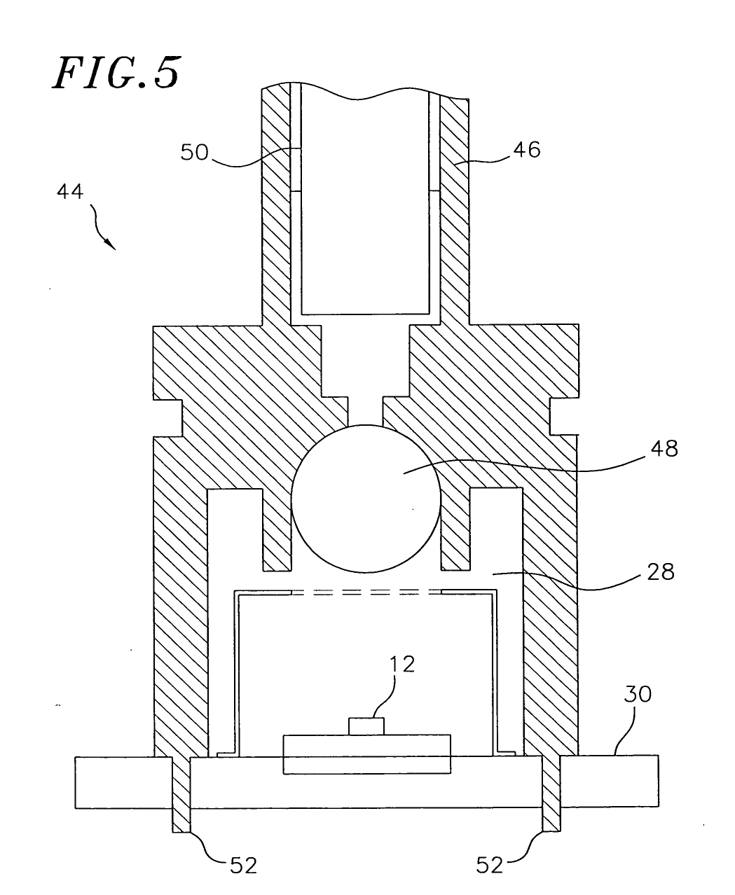

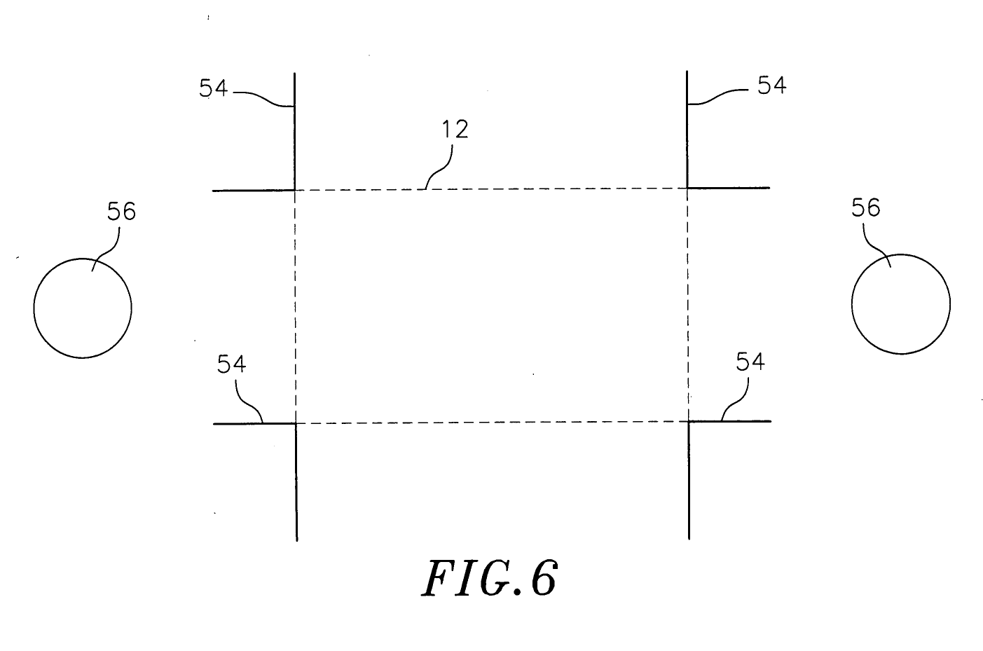

In an alternate embodiment of the present invention FCA 44 is molded directly on substrate 30 utilizing transfer molding technologies. Referring to FIG. 6, registration marks 54 and holes 56 in substrate 30 are used to align optoelectronic device 12 to holes 56 in the substrate 30. The holes 56 in the substrate 30 register the tooling to transfer mold the FCA 44 directly onto substrate 30.

As an alternate to active alignment, vision alignment may also utilize the same registration marks 54 and holes 56 to precisely align the FCA 44 and optical module 28. The FCA 44 may be mounted on a set of well-controlled stages (not shown), allowing for translation and rotation as is known to those skilled in the art. The optical system may then utilize image processing to perform pattern matching of the predetermined features embedded on substrate 30 and FCA 44.

The advantage of a vision system is that alignment may be done in an automated fashion, stepping from device to device on a regular pattern on a substrate 30. This cassette driven approach can provide substantially higher throughput on the equipment, thereby reducing overall cost.

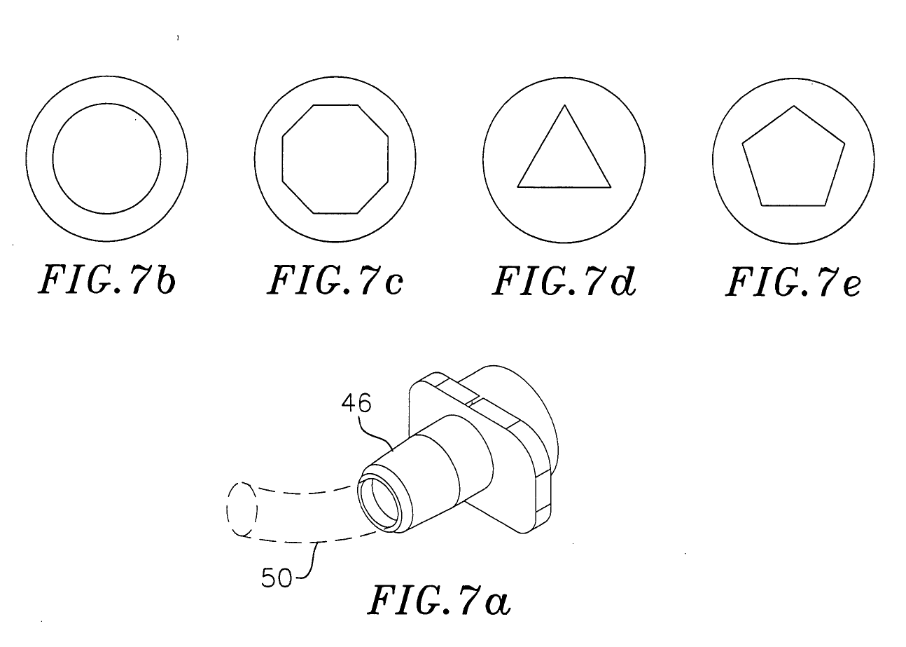

Conventionally, a cylindrical fiber 50 is inserted into the cylindrical barrel 46 of the FCA 44 as is shown in FIG. 7a. FIG. 7b is a front view of a cylindrical barrel 46 illustrating that strict tolerances must be maintained on the mating of fiber 50 and barrel 46 to prevent the end face of fiber 50 from moving out of alignment with the lens 48 of FCA 44 when pressures are applied under normal use (see FIG. 6). However, maintaining perfect concentricity of the plastic molded barrel 46 as well as strictly maintaining the same precise shape throughout the length of the barrel 46 can be difficult.

Therefore, in a still further embodiment of the present invention, barrel 46 of FCA 44 is non-cylindrical in cross-section as seen in FIG. 7c-e. The alternate embodiments include flat sidewalls, that may be more readily manufactured with strict tolerances through plastic molding. The cylindrical fiber 50 is then inserted into a hole where the flat portions make contact with the fiber and hold the fiber in place with greater accuracy when pressures are applied.

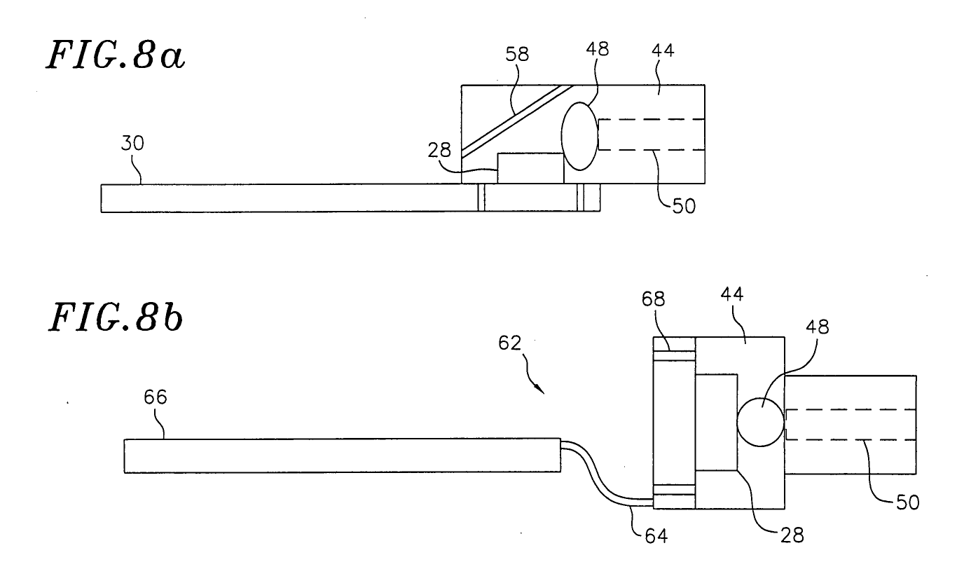

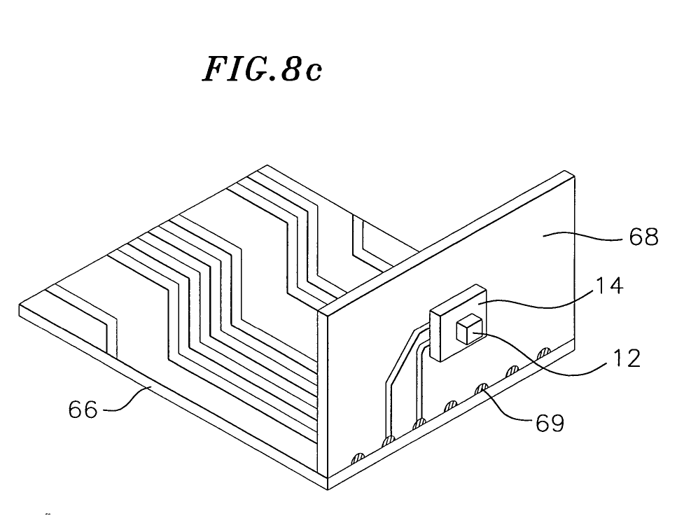

In accordance with the present invention, optical module 28 may be built on a plurality of substrates including rigid, flex, or flex-rigid substrate as well as ceramic or silicon substrates. FIG. 8a is a side view of optical module 28 built on a rigid substrate 30. A fiber coupling assembly (FCA) 44 positions the end face of fiber 50 relative to the output of optical module 28. A total internal reflection mirror 58 is used with a collimating or focusing lens 48 to reflect the light 90 degrees and focus it with the end face of fiber 50.

FIG. 8b is a side view of optical module 28 built on a flex-rigid substrate 62. The flex-rigid substrate 62 according to the present invention comprises a multi-layered, flexible printed circuit board 64 that is between and electrically connects a rigid motherboard 66 and a rigid daughter board 68. Optical module 28 is built on and coupled to conductors of the rigid daughter board 68. The flex-rigid substrate 62 is advantageous for applications wherein optoelectronic device 12 is a VCSEL. The right angle between the mother and daughter boards in the flex-rigid design brings the output facet of a VCSEL substantially into parallel alignment with the plane of the end face of optical fiber 50. Since VCSELs are surface emitters, relatively simple optical components are adequate for a flex rigid configuration to focus the output light of optical module 28 into fiber 50.

FIG. 8c shows an alternate electrical connection between the mother and daughter substrates that is similar to FIG. 8b. In accordance with this alternate embodiment the flex circuit making the electrical connection between the mother and daughter substrate is replaced with castellations 69 on the daughter substrate that provide the 90 degree electrical connection.

Another embodiment of the present invention molds a FCA or an optical subassembly (OSA) over the optical device directly on a substrate. This is known as plastic encapsulation. Plastic encapsulation of an optical device was disclosed in U.S. Provisional Patent Application No. 60/125,230, entitled “VCSEL POWER MONITORING SYSTEM INCORPORATING TILTED WINDOW DESIGN”, and U.S. Pat. No. 6,015,239, entitled “PASSIVELY ALIGNED OPTO-ELECTRONIC COUPLING ASSEMBLY”, the contents of both of which are incorporated herein by reference.

Beneficially, a plastic package offers comparative cost advantages and is more readily manufactured than a conventional metal package. The plastic encapsulation should preferably be high temperature, optical grade plastic suitable for encapsulating a laser and other semiconductor components while also allowing transmission of light. In addition the thermal expansion coefficient of the encapsulant should match that of the items being encapsulated to minimize thermal stresses placed upon the various transceiver components during temperature cycling. The encapsulant should sufficiently adhere to the optical component to minimize delamination or the creation of air gaps during the molding process. The encapsulant should also have low mobile ions to minimize the corrosion of the components that are being encapsulated. Dexter Electronic Materials Division, Industry, sells a suitable plastic under the trademark HYSOL®, as does General Electric Plastics Division under the trademark Ultem®.

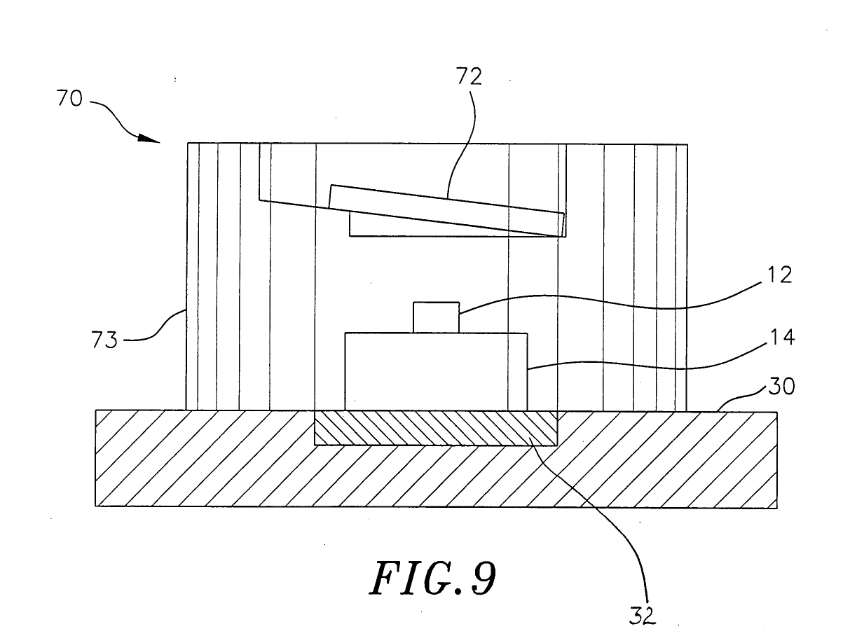

Referring to FIG. 9, a presently preferred embodiment of a plastic encapsulated OSA 70 has substantially the same dimensions as a conventional subassembly. An exemplary embodiment substantially encapsulates an optoelectronic device 12 and a power monitoring photodetector 14. The photodetector 14 may be epoxy bonded, as is known in the art, on a conductive mounting pad 32 on substrate 30. The package includes a cylindrical body portion 73 formed by the encapsulation material which replaces the TO Can assembly of FIG. 5.

The plastic encapsulation package may contain a tilted window beam splitter 72 for obtaining accurate monitoring and feedback. The beam splitter 72 may be formed from an air gap, grating, glass or plastic or adjacent media of differing indices of refraction. The beam splitter may be fabricated in accordance with a number of techniques known in the art. In a preferred embodiment the beam splitter 72 window is simply the top surface of the encapsulant material.

The various embodiments of the invention take into account the differing indices of refraction to provide the proper feedback of radiated light toward the photodiode while choosing the geometries to ensure a consistent sampling of the beam at both high and low beam divergence resulting from different drive currents and temperatures. The beam splitter provides the necessary refraction to appropriately direct a representative sample of the radiated beam onto the photodetector while transmitting an undistorted beam into the output.

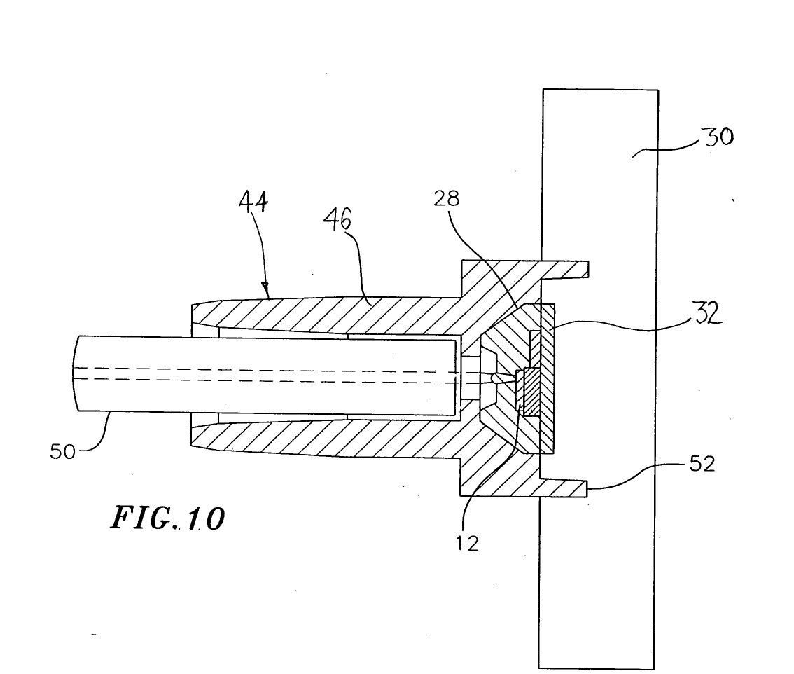

The formation of cylindrical body portion 73 can be accomplished by one of a variety of known methods. Typically, the optical device is positioned inside a molding tool where pre-heated plastic is injected to encapsulate all the parts. This alternate embodiment is not limited to cylindrical shapes. Rather plastic encapsulation may be readily adapted to a variety of shapes to achieve enhanced optical alignment with the transmission medium. In addition, the same encapsulation method may be used to mold the entire FCA onto the substrate as is shown in FIG. 10.

In another embodiment of the present invention, a plurality of individual or arrayed active devices may be housed in the active device package within the encapsulant material. The predetermined configuration of the encapsulant material cooperates with the housing outline of the light guide end housing so as to passively align the light active area of each active device with an end face of one of a plurality of elongated light guides which are supported by the light guide end housing Those skilled in the art will understand that various modifications may be made to the described embodiment. Optical module 28 can include any optical transmitter, any optical receiver, or any integrated transceiver, i.e. an integrated monolithic package with a transmitter, monitoring photodetector, a photodiode receiver, and an amplifier integrated into a single device. In addition, the present invention can be readily utilized with a variety of optical devices including, VCSELs, edge emitter lasers, photodiodes, LEDs etc.

Further, alternate embodiments wherein the optical module 28 is hermetically sealed may also be used. Similarly, optical module 28 need not be directly mounted onto substrate 30. Optical module 28 can be operably coupled to substrate 30 in a variety of ways, including but not limited to a standoff, another electro-optic device such as a photodetector, or via a common electrical device (e.g. integrated circuits).

Moreover, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention.

What is claimed is:

1. An optical device package comprising:
a substrate comprising a flex-rigid circuit board assembly wherein said flex-rigid circuit board assembly comprises a rigid daughter board coupled to a rigid mother board by a flexible circuit substrate such that said daughter board is in electrical communication with said mother board, said daughter board having a mounting surface;
an optoelectronic device having a lower mounting surface operably coupled to said mounting surface of said daughter board wherein said optoelectronic device is in electrical communication with said daughter board,
said optoelectronic device further having an active upper surface disposed substantially parallel to said mounting surface of said substrate and being configured to emit or receive light normal to said active upper surface;
a fiber coupling device having a body portion coupled to said mounting surface of said daughter board, said fiber coupling device including a barrel portion extending from said body portion in a direction substantially perpendicular to said mounting surface of said daughter board, said barrel portion being configured to operably engage a fiber optic cable;
an alignment guide structure for passively aligning said fiber coupling device with said optoelectronic device; and
an enclosure coupled to said substrate that houses said optoelectronic device.

2. The optical device package of claim 1 wherein said fiber coupling device further comprises a focusing lens.

3. The optical device package of claim 1 wherein said alignment guide structure further comprises:
molded guide member operably coupled to said fiber coupling device; and
vias in said mounting surface of said daughter board which operably engage said molded guide members.

4. The optical device package of claim 1 wherein said body portion of said fiber coupling device is integrally molded with said optoelectronic device such that said optoelectronic device is imbedded within said fiber coupling device, said fiber coupling device being configured and arranged to transmit light.

5. The optical device package of claim 1 wherein said optoelectronic device is a VCSEL.

6. The optical device package of claim 1 wherein said daughter board is arranged substantially perpendicular to said mother board within said enclosure.

7. The optical device package of claim 6 wherein said fiber coupling device further comprises a focusing lens.

8. The optical device package of claim 6 wherein said alignment guide structure further comprises:
molded guide member operably coupled to said fiber coupling device; and
vias in said mounting surface of said daughter board which operably engage said molded guide members.

9. The optical device package of claim 6 wherein said body portion of said fiber coupling device is integrally molded with said optoelectronic device such that said optoelectronic device is imbedded within said fiber coupling device, said fiber coupling device being configured and arranged to transmit light.

10. The optical device package of claim 6 wherein said optoelectronic device is a VCSEL.
